(19) United States
(12) Patent Application Publication
(10) Pub. No.: US 2026/0129390 A1
(43) Pub. Date: May 7, 2026

(54) SPATIAL AUDIO RECOVERY APPARATUS, SPATIAL AUDIO RECOVERING METHOD, AND PROGRAM

(71) Applicant: NTT, Inc., Tokyo (JP)

(72) Inventors: Kimitaka TSUTSUMI, Musashino-shi, Tokyo (JP); Kenta IMAIZUMI, Musashino-shi, Tokyo (JP)

(21) Appl. No.: 19/117,149

(22) PCT Filed: Oct. 3, 2022
(86) PCT No.: PCT/JP2022/036973

§ 371 Date: Mar. 31, 2025

(51) Int. Cl. H04S 7/00; G06V 10/40; G06V 10/82; G06V 20/40; G10L 19/008

(52) U.S. Cl. CPC H04S 7/30; G10L 19/008; G06V 10/40; G06V 10/82; G06V 20/46; H04S 2400/11; H04S 2420/03; H04S 2420/11

(57) ABSTRACT

A spatial audio restoration device of an embodiment includes a video feature amount calculation unit that calculates a video feature amount on the basis of video information, an audio feature amount calculation unit that calculates an audio feature amount on the basis of audio information that is a monaural sound corresponding to the video information, and a coefficient calculation unit that calculates a high-order Ambisonics coefficient on the basis of the video feature amount and the audio feature amount.

### TECHNICAL FIELD

Embodiments relate to a spatial audio restoration device, a spatial audio restoration method, and a program.

### BACKGROUND ART

A spatial audio restoration technique for virtually restoring a spatial audio formed in a real space using headphones or a plurality of speakers has been studied. As examples of spatial audio restoration techniques, wavefront synthesis techniques and Ambisonics are known. By the wavefront synthesis technique and Ambisonics, spatial audio is accurately restored on the basis of a sound field observed at a sound collection point. However, a large-scale microphone array is necessary to observe an accurate sound field. Thus, it may be difficult to observe an accurate sound field.

As a method for restoring a spatial audio without observing an accurate sound field, a method for outputting a coefficient of first-order Ambisonics using a neural network and using an omnidirectional video and an optical flow, and monaural sound as inputs has been proposed.

### CITATION LIST

### Patent Literature

Patent Literature 1: JP 10-294999 A

### Non Patent Literature

Non Patent Literature 1: P. Morgado et al., “Self-supervised generation of spatial audio for 360 video”, in proc. NeurIPS 2018, pp. 360-370, 2018.

### SUMMARY OF INVENTION

### Technical Problem

However, by the proposed method, after the monaural sound is separated into a plurality of sound sources corresponding to a video, each of the plurality of separated sound sources is subjected to sound image localization. Thus, in the proposed method, the following problem occurs in restoring the rich spatial audio corresponding to the video.
There is an upper limit to the number of sound sources separated corresponding to the video.
It is difficult to model the effect of reverberation.
Individual modules are required to achieve procedures such as sound source separation, which increases memory volume.

The present invention has been made in view of the above circumstances, and an object thereof is to provide a means for restoring a rich spatial audio corresponding to a video.

### Solution to Problem

A spatial audio restoration device according to one aspect includes a video feature amount calculation unit, an audio feature amount calculation unit, and a coefficient calculation unit. The video feature amount calculation unit calculates a video feature amount on the basis of video information. The audio feature amount calculation unit calculates an audio feature amount on the basis of audio information that is a monaural sound corresponding to the video information. The coefficient calculation unit calculates a high-order Ambisonics coefficient on the basis of the video feature amount and the audio feature amount.

### Advantageous Effects of Invention

According to an embodiment, it is possible to provide a means for restoring a rich spatial audio corresponding to a video.

### BRIEF DESCRIPTION OF DRAWINGS

FIG. 1 is a diagram illustrating an example of a configuration of a spatial audio restoration system according to the first embodiment.

FIG. 2 is a block diagram illustrating an example of a hardware configuration of a spatial audio restoration device according to the first embodiment.

FIG. 3 is a block diagram illustrating an example of a configuration of a learning function of the spatial audio restoration device according to the first embodiment.

FIG. 4 is a block diagram illustrating an example of a configuration of a restoration function of the spatial audio restoration device according to the first embodiment.

FIG. 5 is a flowchart illustrating an example of a learning operation in the spatial audio restoration device according to the first embodiment.

FIG. 6 is a flowchart illustrating an example of a restoration operation in the spatial audio restoration device according to the first embodiment.

FIG. 7 is a block diagram illustrating an example of a configuration of a learning function of a spatial audio restoration device according to the second embodiment.

FIG. 8 is a block diagram illustrating an example of a configuration of a restoration function of the spatial audio restoration device according to the second embodiment.

FIG. 9 is a flowchart illustrating an example of a learning operation in the spatial audio restoration device according to the second embodiment.

FIG. 10 is a flowchart illustrating an example of a restoration operation in the spatial audio restoration device according to the second embodiment.

FIG. 11 is a block diagram illustrating an example of a configuration of a learning function of a spatial audio restoration device according to the third embodiment.

FIG. 12 is a block diagram illustrating an example of a configuration of a restoration function of the spatial audio restoration device according to the third embodiment.

FIG. 13 is a flowchart illustrating an example of a learning operation in the spatial audio restoration device according to the third embodiment.

FIG. 14 is a flowchart illustrating an example of a restoration operation in the spatial audio restoration device according to the third embodiment.

### DESCRIPTION OF EMBODIMENTS

Hereinafter, embodiments will be described with reference to the drawings. Note that in the following description, components having the same function and configuration are denoted by the same reference numerals.

### 1. First Embodiment

### 1.1 Configuration

A configuration of a spatial audio restoration device according to the first embodiment will be described.

### 1.1.1 Spatial Audio Restoration System

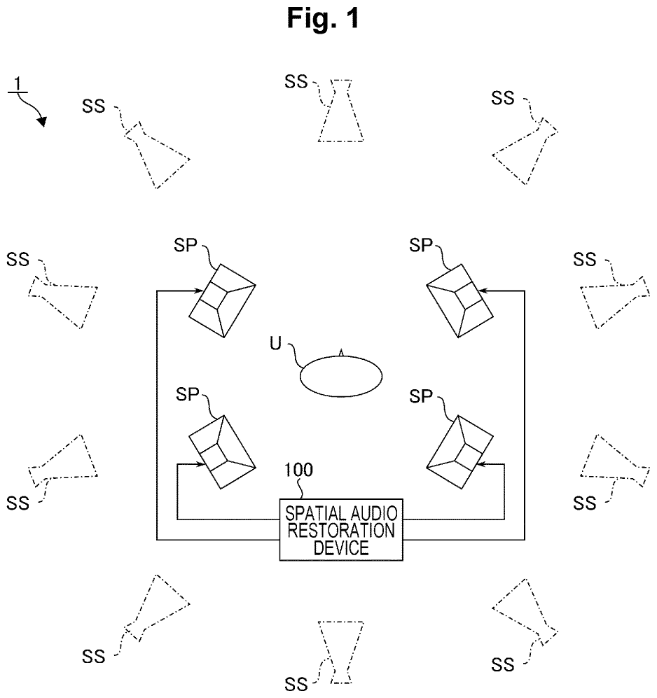

First, a configuration of a spatial audio restoration system including the spatial audio restoration device according to the first embodiment will be described. FIG. 1 is a block diagram illustrating an example of a configuration of the spatial audio restoration system according to the first embodiment.

As illustrated in FIG. 1, a spatial audio restoration system 1 is a system for a user U to experience spatial audio in conjunction with a video. The spatial audio restoration system 1 includes a plurality of speakers SP and a spatial audio restoration device 100.

The plurality of speakers SP are arranged around the user U. In the example of FIG. 1, a case where the plurality of speakers SP is arranged away from the user U is illustrated, but the speakers are not limited thereto. The plurality of speakers SP may be, for example, devices worn and used by the user U, such as headphones.

The spatial audio restoration device 100 is, for example, a terminal. The spatial audio restoration device 100 calculates a high-order Ambisonics coefficient on the basis of video information and audio information that is a monaural sound corresponding to the video information. The spatial audio restoration device 100 decodes output audio information output from the plurality of speakers SP on the basis of the calculated high-order Ambisonics coefficient.

The high-order Ambisonics coefficient corresponds to a sound field formed by a plurality of virtual sound sources SS. The plurality of virtual sound sources SS is sound sources virtually arranged in any number at any position outside the plurality of speakers SP with respect to the user U. The plurality of virtual sound sources SS does not correspond to the positions and the number of actual sound sources identified from the video information. That is, the positions and the number of the plurality of virtual sound sources SS are determined by the user U independently of the video information.

### 1.1.2 Hardware Configuration of Spatial Audio Restoration Device

Next, a hardware configuration of the spatial audio restoration device according to the first embodiment will be described.

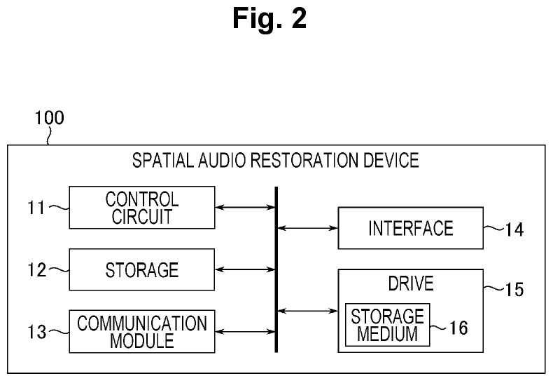

FIG. 2 is a block diagram illustrating an example of a hardware configuration of the spatial audio restoration device according to the first embodiment. As illustrated in FIG. 2, the spatial audio restoration device 100 includes a control circuit 11, a storage 12, a communication module 13, an interface 14, a drive 15, and a storage medium 16.

The control circuit 11 is a circuit that entirely controls each component of the spatial audio restoration device 100. The control circuit 11 includes a central processing unit (CPU), a random access memory (RAM), a read only memory (ROM), and the like.

The storage 12 is an auxiliary storage device of the spatial audio restoration device 100. The storage 12 is, for example, a hard disk drive (HDD), a solid state drive (SSD), a memory card, or the like. The storage 12 stores data used for a learning operation and a restoration operation. In addition, the storage 12 may store a program for executing the learning operation and the restoration operation.

The restoration operation is an operation of generating audio information in which a spatial audio is restored. The learning operation is an operation of learning parameters for restoring the spatial audio. Details of the learning operation and the restoration operation will be described later.

The communication module 13 is a circuit used to transmit and receive data to and from the plurality of speakers SP.

The interface 14 is a circuit for communicating information between the user U and the control circuit 11. The interface 14 includes an input device and an output device. The input device includes, for example, a touch panel, an operation button, and the like. The output device includes, for example, a liquid crystal display (LCD), an electroluminescence (EL) display, or the like. The interface 14 converts an input from the user U into an electrical signal, and then transmits the electrical signal to the control circuit 11. The interface 14 outputs an execution result based on the input from the user U to the user U.

The drive 15 is a device for reading software stored in the storage medium 16. The drive 15 includes, for example, a compact disk (CD) drive, a digital versatile disk (DVD) drive, and the like.

The storage medium 16 is a medium that stores software by electrical, magnetic, optical, mechanical, or chemical action. The storage medium 16 may store a program for executing the learning operation and the restoration operation.

### 1.1.3 Functional Configuration of Spatial Audio Restoration Device

Next, a functional configuration of the spatial audio restoration device according to the first embodiment will be described. The spatial audio restoration device 100 has a learning function for executing the learning operation and a restoration function for executing the restoration operation.

### 1.1.3.1 Learning Function

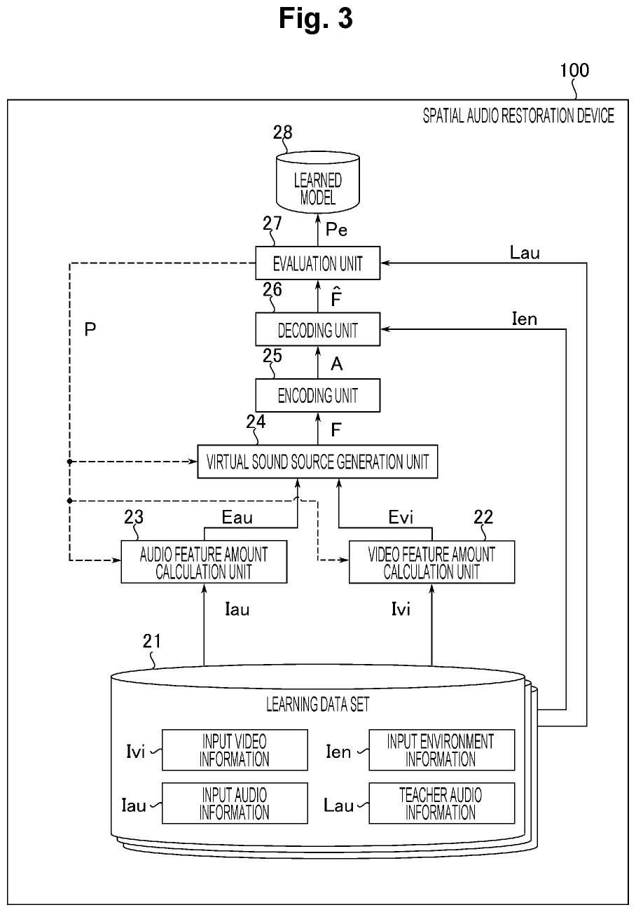

FIG. 3 is a block diagram illustrating an example of a configuration of a learning function of the spatial audio restoration device according to the first embodiment.

The CPU of the control circuit 11 deploys a learning operation program stored in the storage 12 or the storage medium 16 into the RAM. Then, the CPU of the control circuit 11 interprets and executes the program deployed in the RAM. Thus, the control circuit 11 functions as a computer including the video feature amount calculation unit 22, the audio feature amount calculation unit 23, the virtual sound source generation unit 24, the encoding unit 25, the decoding unit 26, and the evaluation unit 27. Further, the storage 12 stores a plurality of learning data sets 21 and a learned model 28.

The plurality of learning data sets 21 is a cluster of data sets used for a single learning operation. In other words, each of the learning data sets 21 is a unit of data sets used for a single learning operation. Each of the plurality of learning data sets 21 includes input video information Ivi, input audio information Iau, input environment information Ien, and teacher audio information Lau.

The input video information Ivi includes one more pieces of image data. In a case where a plurality of pieces of image data is included, the input video information Ivi is, for example, a plurality of pieces of image data continuously captured in time series. The image data may be a color image or a monochrome image. The image data may be an omnidirectional image but need not be a complete omnidirectional image (for example, even in the case of a panoramic image).

The input audio information Iau is monaural sound data associated with the same time series as the input video information Ivi. The input audio information Iau is, for example, monaural sound data recorded at a recording position substantially coinciding with the capturing position of the input video information Ivi. In the following description, the recording position of the input audio information Iau is also referred to as a “center position”. The center position corresponds to the position of the user U.

The input environment information Ien is data indicating a reproduction environment of the spatial audio (sound field) restored by the spatial audio restoration device 100. The input environment information Ien includes, for example, relative positions from the center positions of the plurality of speakers SP, the number of the plurality of speakers SP, and the like.

The teacher audio information Lau is audio data observed in the reproduction environment (that is, the position where the plurality of speakers SP is arranged) included in the input environment information Ien in the true sound field formed by the actual sound source corresponding to the input video information Ivi.

The video feature amount calculation unit 22 includes a neural network having a weight and a bias term that function as parameters. The neural network in the video feature amount calculation unit 22 is configured to calculate a video feature amount Evi using the input video information Ivi as an input. The video feature amount Evi includes one or more image feature amounts. The one or more image feature amounts included in the video feature amount Evi correspond to, for example, one or more pieces of image data included in the input video information Ivi. That is, the neural network in the video feature amount calculation unit 22 calculates the image feature amount corresponding to the image data using one piece of image data in the input video information Ivi as an input. The video feature amount calculation unit 22 transmits, to the virtual sound source generation unit 24, the video feature amount Evi obtained by combining the calculated one or more image feature amounts in time series.

Note that the video feature amount calculation unit 22 may calculate the optical flow on the basis of the input video information Ivi. In this case, the neural network in the video feature amount calculation unit 22 may calculate the video feature amount Evi using the calculated optical flow as a further input.

The audio feature amount calculation unit 23 includes a neural network having a weight and a bias term that function as parameters. The neural network in the audio feature amount calculation unit 23 is configured to calculate an audio feature amount Eau using the input audio information Iau as an input. Specifically, for example, the neural network in the audio feature amount calculation unit 23 calculates the feature amount corresponding to a portion of monaural sound using a portion of monaural sound corresponding to one piece of image data in the input video information Ivi in the input audio information Iau as an input. The audio feature amount calculation unit 23 transmits the audio feature amount Eau in which one or more calculated feature amounts are combined in time series to the virtual sound source generation unit 24.

The virtual sound source generation unit 24 includes a neural network having a weight and a bias term that function as parameters. The neural network in the virtual sound source generation unit 24 is configured to calculate virtual sound source information F using the video feature amount Evi and the audio feature amount Eau as inputs. The virtual sound source generation unit 24 transmits the generated virtual sound source information F to the encoding unit 25.

The virtual sound source information F is defined by the following Expression (1).

$$[ Math . 1 ]$$

$$F = {[ {F}_{1} ( k , t ) {F}_{2} ( k , t ) … {F}_{X} ( k , t ) ]}^{T} \qquad ( 1 )$$

Here, k is a wave number. t is time. X is the number of the plurality of virtual sound sources SS. Note that it is assumed that the i-th virtual sound source SS is located in a direction of (θᵢ, φᵢ) (1≤i≤X) from the center position. θ is an elevation angle. φ is an azimuth angle. X and (θᵢ, φᵢ) are determined independently of input video information Ivi.

The encoding unit 25 includes an encoder corresponding to high-order Ambisonics. The encoder in the encoding unit 25 is configured to calculate a high-order Ambisonics coefficient A using the virtual sound source information F as an input. The encoding unit 25 transmits the calculated high-order Ambisonics coefficient A to the decoding unit 26.

The high-order Ambisonics coefficient A is calculated according to the following Expressions (2), (3), and (4).

$$[ Math . 2 ]$$

$$A = {Y}^{†} F \qquad ( 2 )$$

$$Y = [ \begin{matrix}{Y}_{0}^{0} ( {θ}_{1} , {ϕ}_{1} ) & {Y}_{1}^{- 1} ( {θ}_{1} , {ϕ}_{1} ) & … & {Y}_{N}^{N} ( {θ}_{1} , {ϕ}_{1} ) \\ {Y}_{0}^{0} ( {θ}_{2} , {ϕ}_{2} ) & {Y}_{1}^{- 1} ( {θ}_{2} , {ϕ}_{2} ) & … & {Y}_{N}^{N} ( {θ}_{2} , {ϕ}_{2} ) \\ ⋮ & ⋮ & ⋱ & ⋮ \\ {Y}_{0}^{0} ( {θ}_{X} , {ϕ}_{X} ) & {Y}_{1}^{- 1} ( {θ}_{X} , {ϕ}_{X} ) & … & {Y}_{N}^{N} ( {θ}_{X} , {ϕ}_{X} )\end{matrix} ] \qquad ( 3 )$$

$$A = {[ {A}_{00} ( k , t ) {A}_{- 11} ( k , t ) … {A}_{NN} ( k , t ) ]}^{T} \qquad ( 4 )$$

Here, Yₙ^{m}(θ, φ) is a spherical harmonic function of the order n and the order m (0≤n≤N, −n≤m≤n). N is the maximum value of the order. The matrix Y^{†} is a pseudo inverse matrix of Y.

The decoding unit 26 includes a decoder corresponding to high-order Ambisonics. The decoder in the decoding unit 26 is configured to calculate output audio information F\hat{ } using the input environment information Ien and the high-order Ambisonics coefficient A as inputs. The decoding unit 26 transmits the calculated output audio information F\hat{ } to the evaluation unit 27.

The output audio information F\hat{ } is defined by the following Expression (5).

$$[ Math . 3 ]$$

$$\hat{F} = {[ {\hat{F}}_{1} ( k , t ) {\hat{F}}_{2} ( k , t ) {\hat{F}}_{\hat{X}} ( k , t ) ]}^{T} \qquad ( 3 )$$

X\hat{ } is the number of the plurality of speakers SP. Note that it is assumed that the 1-th speaker SP is located in the direction of ((θ₁, φ₁) (1≤1≤X\hat{ }) from the center position. The number X\hat{ } of speakers SP and the direction from the center position (θ₁, φ₁) are included in the input environment information Ien.

The audio information F₁\hat{ }(k, t) reproduced from the 1-th speaker SP is calculated according to the following Expressions (6) and (7).

$$[ Math . 4 ]$$

$${\hat{F}}_{l} ( k , t ) = {\sum }_{n = 0}^{N} {\sum }_{m = - n}^{n} {A}_{nn} ( k , t ) {Y}_{n}^{m} ( {θ}_{l} , {ϕ}_{l} ) = \hat{Y} A \qquad ( 6 )$$

$$\hat{Y} = [ {Y}_{0}^{0} ( {θ}_{l} , {ϕ}_{l} ) … {Y}_{N}^{N} ( {θ}_{l} , {ϕ}_{l} ) ] \qquad ( 7 )$$

The evaluation unit 27 includes an updater for the parameter P. The evaluation unit 27 updates the parameter P so as to minimize an error of the output audio information F\hat{ } with respect to the teacher audio information Lau. Specifically, the parameter P is a bias term and a weight that determine the characteristics of the neural network provided in each of the video feature amount calculation unit 22, the audio feature amount calculation unit 23, and the virtual sound source generation unit 24. For calculating the parameter P, the evaluation unit 27 uses, for example, error back propagation algorithm.

Every time the parameter P is updated, the evaluation unit 27 applies the updated parameter P to each of the video feature amount calculation unit 22, the audio feature amount calculation unit 23, and the virtual sound source generation unit 24. When an evaluation end condition is satisfied, the evaluation unit 27 causes the last updated parameter P to be stored in the storage 12 as the learned model 28. Hereinafter, the parameter P as the learned model 28 may be described as a parameter Pe to be distinguished from the parameter P.

The evaluation end condition may be, for example, that all of the plurality of learning data sets 21 are selected. The evaluation end condition may be, for example, that the update amount of the parameter P is equal to or less than a predetermined threshold value. The evaluation end condition may be, for example, that the update of the parameter P is repeated a predetermined number of times.

### 1.1.3.2 Restoration Function

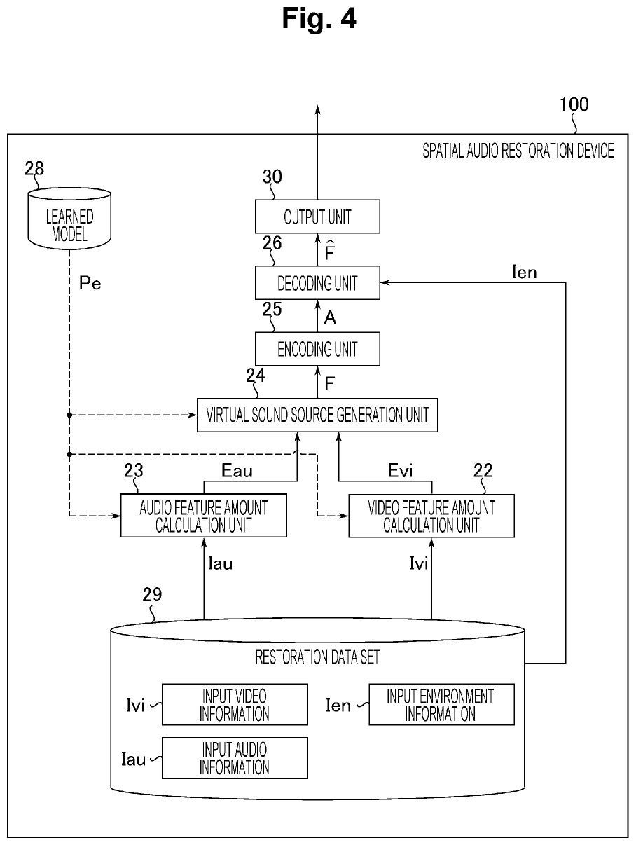

FIG. 4 is a block diagram illustrating an example of a configuration of a restoration function of the spatial audio restoration device according to the first embodiment.

The CPU of the control circuit 11 deploys a restoration operation program stored in the storage 12 or the storage medium 16 into the RAM. Then, the CPU of the control circuit 11 interprets and executes the program deployed in the RAM. Thus, the control circuit 11 functions as a computer including the video feature amount calculation unit 22, the audio feature amount calculation unit 23, the virtual sound source generation unit 24, the encoding unit 25, the decoding unit 26, and an output unit 30. Further, the storage 12 stores the learned model 28 and a restoration data set 29.

Since the configurations of the video feature amount calculation unit 22, the audio feature amount calculation unit 23, the virtual sound source generation unit 24, the encoding unit 25, and the decoding unit 26 in FIG. 4 are the same as the configurations of the video feature amount calculation unit 22, the audio feature amount calculation unit 23, the virtual sound source generation unit 24, the encoding unit 25, and the decoding unit 26 in FIG. 3, the description thereof will be omitted. Note that the decoding unit 26 transmits the calculated output audio information F\hat{ } to the output unit 30.

The learned model 28 is the parameter Pe generated by the learning operation. The learned model 28 is applied to the neural network provided in each of the video feature amount calculation unit 22, the audio feature amount calculation unit 23, and the virtual sound source generation unit 24 at the time of the restoration operation.

The restoration data set 29 is a data set used for the restoration operation. The restoration data set 29 includes the input video information Ivi, the input audio information Iau, and the input environment information Ien.

The output unit 30 transmits the output audio information F\hat{ } to the plurality of speakers SP. With the above configuration, the spatial audio restoration device 100 can restore the output audio information F\hat{ } using the learned model 28.

### 1.2 Operation

Next, an operation of the spatial audio restoration device according to the first embodiment will be described.

### 1.2.1 Learning Operation

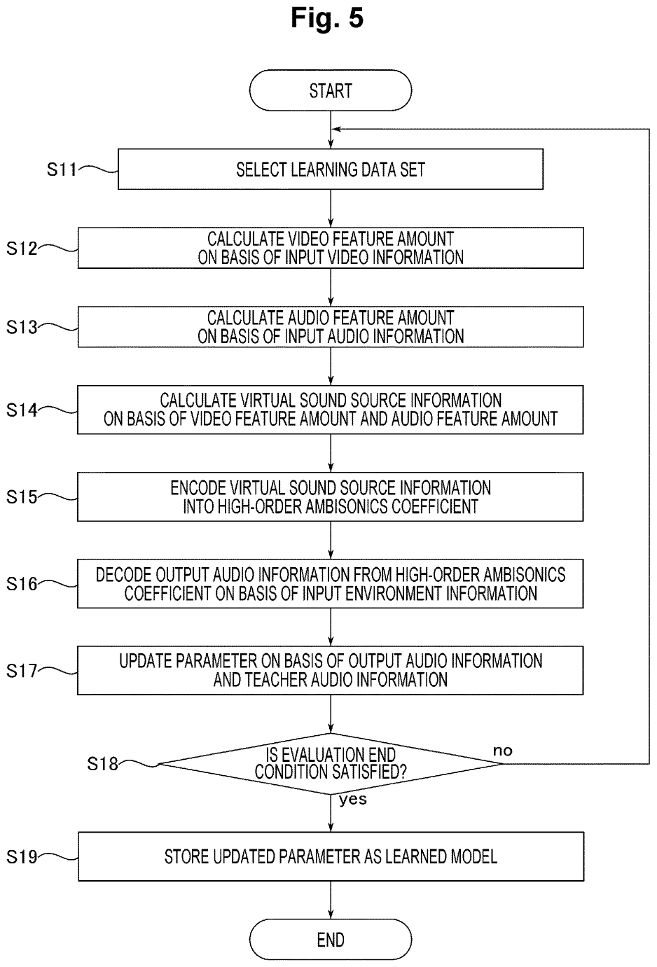

FIG. 5 is a flowchart illustrating an example of a learning operation in the spatial audio restoration device according to the first embodiment.

Upon receiving an instruction to execute the learning operation from the user U (start), the control circuit 11 selects one unselected learning data set 21 from the plurality of learning data sets 21 (S11).

The video feature amount calculation unit 22 calculates the video feature amount Evi on the basis of the input video information Ivi in the learning data set 21 selected in the processing of S11 (S12).

The audio feature amount calculation unit 23 calculates the audio feature amount Eau on the basis of the input audio information Iau in the learning data set 21 selected in the processing of S11 (S13).

The virtual sound source generation unit 24 calculates the virtual sound source information F on the basis of the video feature amount Evi calculated in the processing of S12 and the audio feature amount Eau calculated in the processing of S13 (S14).

The encoding unit 25 encodes the virtual sound source information F calculated in the processing of S14 into a high-order Ambisonics coefficient A (S15).

The decoding unit 26 decodes the output audio information F\hat{ } from the high-order Ambisonics coefficient A encoded in the processing of S15 on the basis of the input environment information Ien in the learning data set 21 selected in the processing of S11 (S16).

The evaluation unit 27 updates the parameter P on the basis of the teacher audio information Lau in the learning data set 21 selected in the processing of S10 and the output audio information F\hat{ } decoded in the processing of S16 (S17).

The evaluation unit 27 determines whether or not the evaluation end condition is satisfied (S18).

If the evaluation end condition is not satisfied (S18; no), the control circuit 11 selects one unselected learning data set 21 from the plurality of learning data sets 21 (S11). Then, the control circuit 11 executes subsequent processing of S12 to S18. In this manner, the processing of S11 to S18 is repeatedly executed until the evaluation end condition is satisfied.

If the evaluation end condition is satisfied (S18; yes), the evaluation unit 27 causes the parameter Pe last updated in the processing of S17 to be stored in the storage 12 as the learned model 28 (S19).

After the processing of S19, the learning operation ends (ends).

### 1.2.2 Restoration Operation

Next, a restoration operation in the spatial audio restoration device according to the first embodiment will be described.

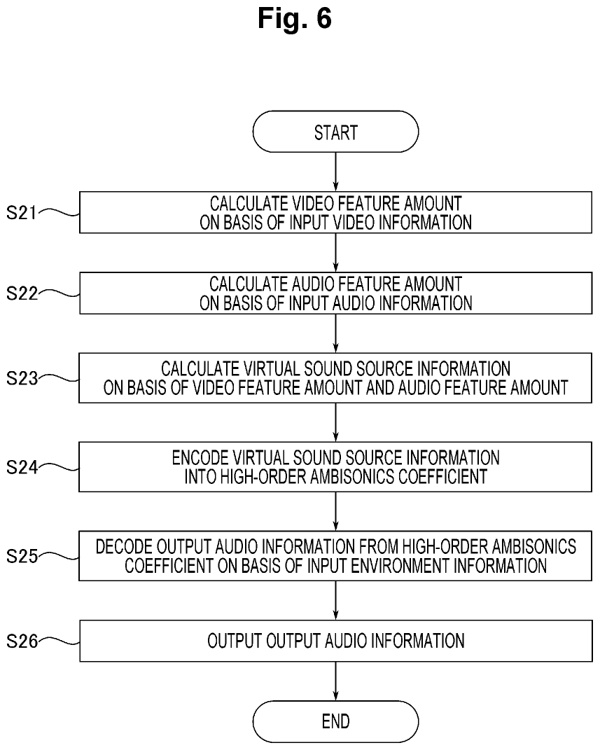

FIG. 6 is a flowchart illustrating an example of a restoration operation in the spatial audio restoration device according to the first embodiment.

Upon receiving an instruction to execute the restoration operation from the user U (start), the video feature amount calculation unit 22 calculates the video feature amount Evi on the basis of the input video information Ivi in the restoration data set 29 (S21).

The audio feature amount calculation unit 23 calculates the audio feature amount Eau on the basis of the input audio information Iau in the restoration data set 29 (S22).

The virtual sound source generation unit 24 calculates the virtual sound source information F on the basis of the video feature amount Evi calculated in the processing of S21 and the audio feature amount Eau calculated in the processing of S22 (S23).

The encoding unit 25 encodes the virtual sound source information F calculated in the processing of S23 into the high-order Ambisonics coefficient A (S24).

The decoding unit 26 decodes the output audio information F\hat{ } from the high-order Ambisonics coefficient A encoded in the processing of S24 on the basis of the input environment information Ien in the restoration data set 29 (S25).

The output unit 30 outputs the output audio information F\hat{ } decoded in the processing of S25 to the plurality of speakers SP (S26).

When the processing of S26 ends, the restoration operation ends (ends).

### 1.3 Effects According to First Embodiment

According to the first embodiment, the video feature amount calculation unit 22 calculates the video feature amount Evi on the basis of the input video information Ivi. The audio feature amount calculation unit 23 calculates the audio feature amount Eau on the basis of the input audio information Iau that is a monaural sound. The virtual sound source generation unit 24 generates the virtual sound source information F on the basis of the video feature amount Evi and the audio feature amount Eau. The virtual sound source information F is a sound field formed by a plurality of virtual sound sources SS independent of the input video information Ivi. Thus, it is possible to reproduce a sound field formed by any number of sound sources regardless of the number of actual sound sources corresponding to the input video information Ivi. Further, reverberation components that are difficult to separate as individual sound sources can also be reproduced. Thus, the rich spatial audio corresponding to the video can be restored.

Further, the encoding unit 25 encodes the virtual sound source information F into the high-order Ambisonics coefficient A. Thus, sound image localization can be performed by deterministic arithmetic processing that does not include the learning operation of the neural network. Therefore, it is possible to suppress an increase in the memory amount necessary for implementing the restoration function.

Further, the decoding unit 26 decodes the output audio information F\hat{ } from the high-order Ambisonics coefficient A. The evaluation unit 27 updates the parameter P of the neural network included in each of the video feature amount calculation unit 22, the audio feature amount calculation unit 23, and the virtual sound source generation unit 24 on the basis of the comparison result between the output audio information F\hat{ } and the teacher audio information Lau. Thus, the estimation accuracy of the video feature amount Evi, the audio feature amount Eau, and the virtual sound source information F by the neural network can be improved.

### 2. Second Embodiment

Next, a spatial audio restoration device according to the second embodiment will be described. The second embodiment is different from the first embodiment in that the high-order Ambisonics coefficient A is calculated from the video feature amount Evi and the audio feature amount Eau without using the virtual sound source information F. Hereinafter, a configuration and operation that are different from those of the first embodiment will be mainly described. The description of the same configurations and operations as those of the first embodiment will be appropriately omitted.

### 2.1 Configuration

A configuration of a spatial audio restoration device according to the second embodiment will be described.

### 2.1.1 Learning Function

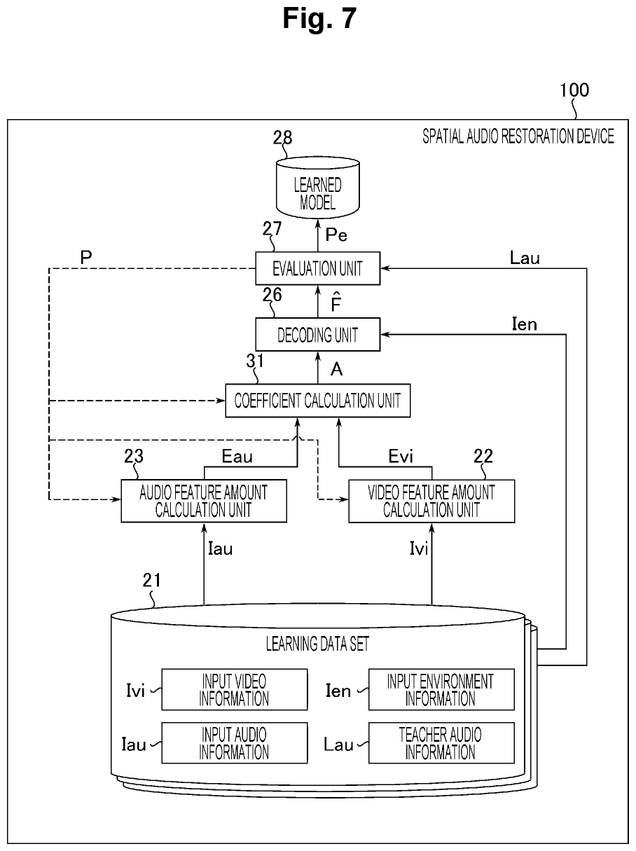

FIG. 7 is a block diagram illustrating an example of a configuration of a learning function of the spatial audio restoration device according to the second embodiment. FIG. 7 corresponds to FIG. 3 in the first embodiment.

The CPU of the control circuit 11 deploys a learning operation program stored in the storage 12 or the storage medium 16 into the RAM. Then, the CPU of the control circuit 11 interprets and executes the program deployed in the RAM. Thus, the control circuit 11 functions as a computer including the video feature amount calculation unit 22, the audio feature amount calculation unit 23, the decoding unit 26, the evaluation unit 27, and a coefficient calculation unit 31. Further, the storage 12 stores the plurality of learning data sets 21 and the learned model 28.

Since the configurations of the plurality of learning data sets 21, the video feature amount calculation unit 22, the audio feature amount calculation unit 23, and the decoding unit 26 in FIG. 7 are equivalent to the configurations of the plurality of learning data sets 21, the video feature amount calculation unit 22, the audio feature amount calculation unit 23, and the decoding unit 26 in FIG. 3, the description thereof will be omitted. Note that the video feature amount calculation unit 22 transmits the calculated video feature amount Evi to the coefficient calculation unit 31. The audio feature amount calculation unit 23 transmits the calculated audio feature amount Eau to the coefficient calculation unit 31.

The coefficient calculation unit 31 includes a neural network having a weight and a bias term that function as parameters. The neural network in the coefficient calculation unit 31 is configured to calculate the high-order Ambisonics coefficient A using the video feature amount Evi and the audio feature amount Eau as inputs. The coefficient calculation unit 31 transmits the generated high-order Ambisonics coefficient A to the decoding unit 26.

The evaluation unit 27 updates the parameter P so as to minimize an error of the output audio information F\hat{ } with respect to the teacher audio information Lau. Specifically, the parameter P is a bias term and a weight that determine the characteristics of the neural network provided in each of the video feature amount calculation unit 22, the audio feature amount calculation unit 23, and the coefficient calculation unit 31. For calculating the parameter P, the evaluation unit 27 uses, for example, error back propagation algorithm.

Every time the parameter P is updated, the evaluation unit 27 applies the updated parameter P to each of the video feature amount calculation unit 22, the audio feature amount calculation unit 23, and the coefficient calculation unit 31. When the evaluation end condition is satisfied, the evaluation unit 27 causes the last updated parameter Pe to be stored in the storage 12 as the learned model 28.

### 2.1.2 Restoration Function

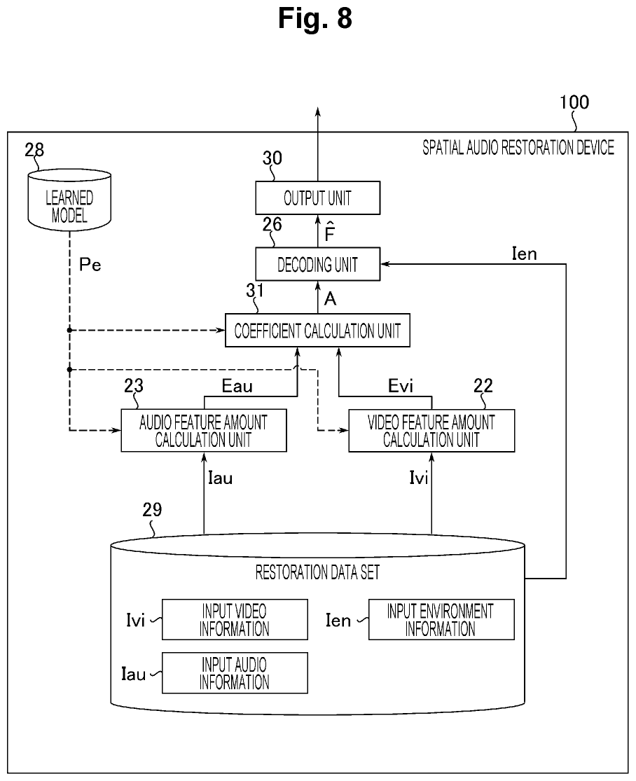

FIG. 8 is a block diagram illustrating an example of a configuration of a restoration function of the spatial audio restoration device according to the second embodiment. FIG. 8 corresponds to FIG. 4 in the first embodiment.

The CPU of the control circuit 11 deploys the restoration operation program stored in the storage 12 or the storage medium 16 into the RAM. Then, the CPU of the control circuit 11 interprets and executes the program deployed in the RAM. Thus, the control circuit 11 functions as a computer including the video feature amount calculation unit 22, the audio feature amount calculation unit 23, the decoding unit 26, the output unit 30, and the coefficient calculation unit 31. Further, the storage 12 stores the learned model 28 and the restoration data set 29.

Since the configurations of the video feature amount calculation unit 22, the audio feature amount calculation unit 23, the decoding unit 26, and the coefficient calculation unit 31 in FIG. 8 are equivalent to the configurations of the video feature amount calculation unit 22, the audio feature amount calculation unit 23, the decoding unit 26, and the coefficient calculation unit 31 in FIG. 7, the description thereof will be omitted. In addition, since the configurations of the restoration data set 29 and the output unit 30 in FIG. 8 are equivalent to the configurations of the restoration data set 29 and the output unit 30 in FIG. 4, the description thereof will be omitted.

The learned model 28 is the parameter Pe generated by the learning operation. The learned model 28 is applied to the neural network provided in each of the video feature amount calculation unit 22, the audio feature amount calculation unit 23, and the coefficient calculation unit 31 at the time of the restoration operation.

### 2.2 Operations

Next, an operation of the spatial audio restoration device according to the second embodiment will be described.

### 2.2.1 Learning Operation

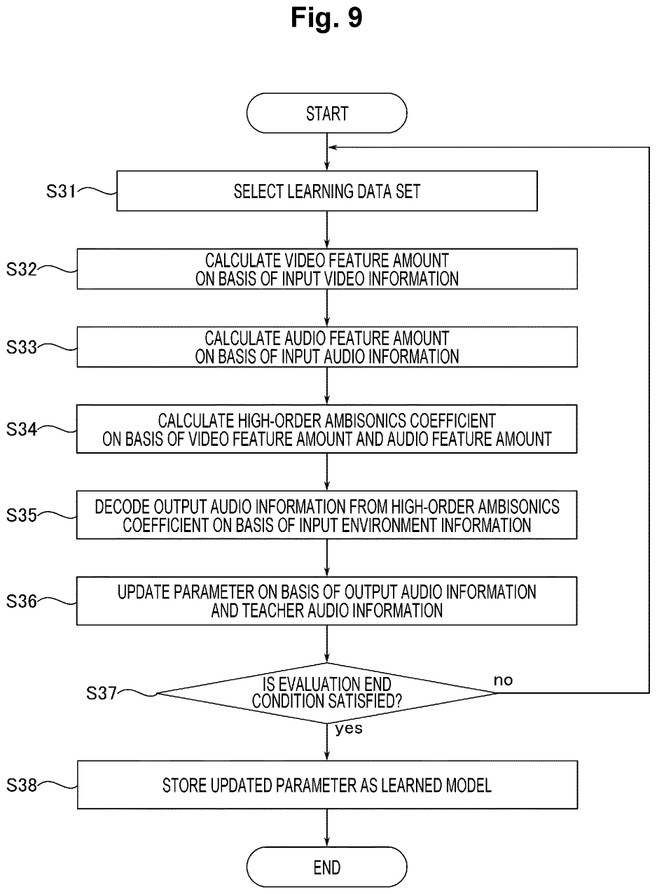

FIG. 9 is a flowchart illustrating an example of a learning operation in the spatial audio restoration device according to the second embodiment. FIG. 9 corresponds to FIG. 5 in the first embodiment.

Upon receiving an instruction to execute the learning operation from the user U (start), the control circuit 11 selects one unselected learning data set 21 from the plurality of learning data sets 21 (S31).

The video feature amount calculation unit 22 calculates the video feature amount Evi on the basis of the input video information Ivi in the learning data set 21 selected in the processing of S31 (S32).

The audio feature amount calculation unit 23 calculates the audio feature amount Eau on the basis of the input audio information Iau in the learning data set 21 selected in the processing of S31 (S33).

The coefficient calculation unit 31 calculates the high-order Ambisonics coefficient A on the basis of the video feature amount Evi calculated in the processing of S32 and the audio feature amount Eau calculated in the processing of S33 (S34).

The decoding unit 26 decodes the output audio information F\hat{ } from the high-order Ambisonics coefficient A calculated in the processing of S34 on the basis of the input environment information Ien in the learning data set 21 selected in the processing of S31 (S35).

The evaluation unit 27 updates the parameter P on the basis of the teacher audio information Lau in the learning data set 21 selected in the processing of S31 and the output audio information F\hat{ } decoded in the processing of S35 (S36).

The evaluation unit 27 determines whether or not the evaluation end condition is satisfied (S37).

If the evaluation end condition is not satisfied (S37; no), the control circuit 11 selects one unselected learning data set 21 from the plurality of learning data sets 21 (S31). Then, the control circuit 11 executes subsequent processing of S32 to S37. In this manner, the processing of S31 to S37 is repeatedly executed until the evaluation end condition is satisfied.

If the evaluation end condition is satisfied (S37; yes), the evaluation unit 27 causes the parameter Pe last updated in the processing of S36 to be stored in the storage 12 as the learned model 28 (S38).

After the processing of S38, the learning operation ends (ends).

### 2.2.2 Restoration Operation

Next, a restoration operation in the spatial audio restoration device according to the second embodiment will be described.

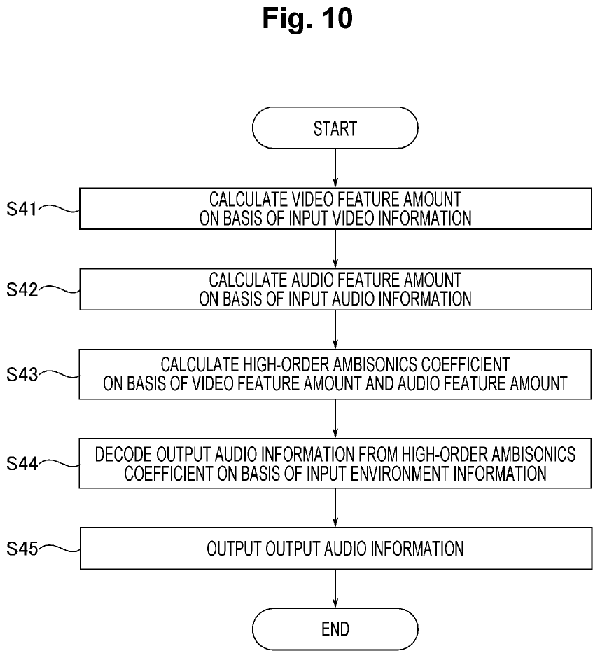

FIG. 10 is a flowchart illustrating an example of a restoration operation in the spatial audio restoration device according to the second embodiment. FIG. 10 corresponds to FIG. 6 in the first embodiment.

Upon receiving an instruction to execute the restoration operation from the user U (start), the video feature amount calculation unit 22 calculates the video feature amount Evi on the basis of the input video information Ivi in the restoration data set 29 (S41).

The audio feature amount calculation unit 23 calculates the audio feature amount Eau on the basis of the input audio information Iau in the restoration data set 29 (S42).

The coefficient calculation unit 31 calculates the high-order Ambisonics coefficient A on the basis of the video feature amount Evi calculated in the processing of S41 and the audio feature amount Eau calculated in the processing of S42 (S43).

The decoding unit 26 decodes the output audio information F\hat{ } from the high-order Ambisonics coefficient A calculated in the processing of S43 on the basis of the input environment information Ien in the restoration data set 29 (S44).

The output unit 30 outputs the output audio information F\hat{ } decoded in the processing of S44 to the plurality of speakers SP (S45).

When the processing of S45 ends, the restoration operation ends (ends).

### 2.3 Effects According to Second Embodiment

According to the second embodiment, the coefficient calculation unit 31 calculates the high-order Ambisonics coefficient A on the basis of the video feature amount Evi and the audio feature amount Eau. Thus, the output audio information F\hat{ } can be obtained without explicitly defining the virtual sound source SS. Therefore, it is possible to suppress an increase in the memory amount required for implementing the restoration function.

Further, the evaluation unit 27 updates the parameter P of the neural network included in each of the video feature amount calculation unit 22, the audio feature amount calculation unit 23, and the coefficient calculation unit 31 on the basis of the comparison result between the output audio information F\hat{ } and the teacher audio information Lau. Thus, the estimation accuracy of the video feature amount Evi, the audio feature amount Eau, and the high-order Ambisonics coefficient A by the neural network can be improved.

### 3. Third Embodiment

Next, a spatial audio restoration device according to the third embodiment will be described. The third embodiment is different from the first embodiment and the second embodiment in that an auxiliary variable λ is used as an additional input when the high-order Ambisonics coefficient A is calculated. Hereinafter, configurations and operations different from those of the first embodiment and the second embodiment will be mainly described. Configurations and operations equivalent to those of the first embodiment and the second embodiment will not be described as appropriate.

### 3.1 Configuration

A configuration of a spatial audio restoration device according to the third embodiment will be described.

### 3.1.1 Learning Function

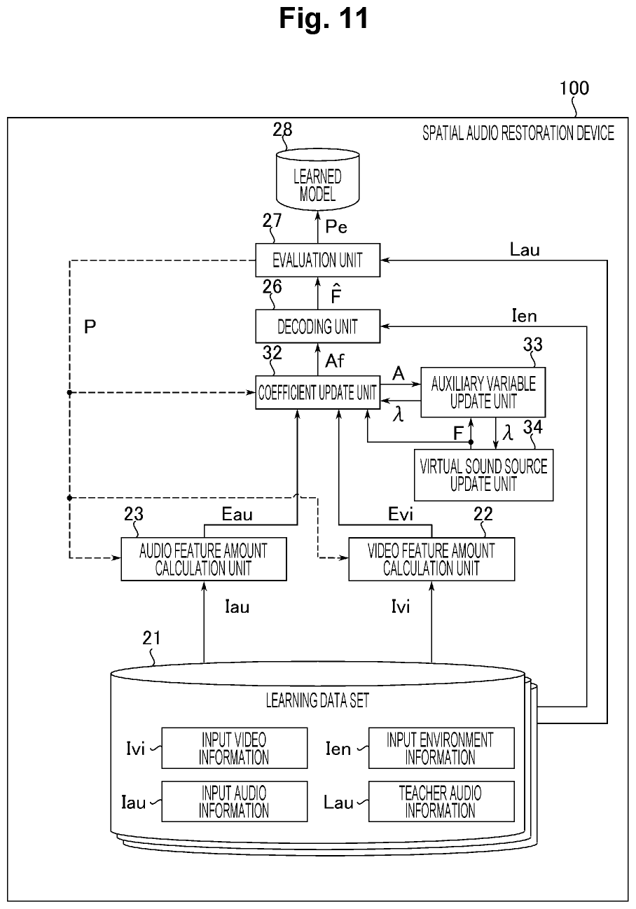

FIG. 11 is a block diagram illustrating an example of a configuration of a learning function of a spatial audio restoration device according to the third embodiment. FIG. 11 corresponds to FIG. 3 in the first embodiment and FIG. 7 in the second embodiment.

The CPU of the control circuit 11 deploys a learning operation program stored in the storage 12 or the storage medium 16 into the RAM. Then, the CPU of the control circuit 11 interprets and executes the program deployed in the RAM. Thus, the control circuit 11 functions as a computer including the video feature amount calculation unit 22, the audio feature amount calculation unit 23, the decoding unit 26, the evaluation unit 27, the coefficient update unit 32, the auxiliary variable update unit 33, and the virtual sound source update unit 34. Further, the storage 12 stores the plurality of learning data sets 21 and the learned model 28.

Since the configurations of the plurality of learning data sets 21, the video feature amount calculation unit 22, the audio feature amount calculation unit 23, and the decoding unit 26 in FIG. 11 are equivalent to the configurations of the plurality of learning data sets 21, the video feature amount calculation unit 22, the audio feature amount calculation unit 23, and the decoding unit 26 in FIG. 3, the description thereof will be omitted. Note that the video feature amount calculation unit 22 transmits the calculated video feature amount Evi to the coefficient update unit 32. The audio feature amount calculation unit 23 transmits the calculated audio feature amount Eau to the coefficient update unit 32.

The coefficient update unit 32, the auxiliary variable update unit 33, and the virtual sound source update unit 34 update the high-order Ambisonics coefficient A, the auxiliary variable λ, and the virtual sound source information F, respectively. The auxiliary variable λ corresponds to a residual (YA-F) between a product (YA) of the high-order Ambisonics coefficient A and the matrix Y and the virtual sound source information F. Each of the high-order Ambisonics coefficient A, the auxiliary variable A, and the virtual sound source information F is updated once by one update operation.

Specifically, the coefficient update unit 32 includes an updater for a neural network having a weight and a bias term that function as parameters, and the high-order Ambisonics coefficient A. The neural network in the coefficient update unit 32 is configured to calculate the high-order Ambisonics coefficient A using the video feature amount Evi, the audio feature amount Eau, the virtual sound source information F, and the auxiliary variable λ as inputs.

The coefficient update unit 32 updates the high-order Ambisonics coefficient A before update with the calculated high-order Ambisonics coefficient A and causes the updated high-order Ambisonics coefficient A to be stored in the storage 12. When the update end condition is satisfied, the coefficient update unit 32 transmits the updated high-order Ambisonics coefficient A to the decoding unit 26 as a high-order Ambisonics coefficient Af.

The update end condition may be, for example, that the number of executions of the update operation is equal to or more than a predetermined threshold value. The update end condition may be, for example, that the update amount of the high-order Ambisonics coefficient A, the auxiliary variable λ, and the virtual sound source information F by the update operation is equal to or less than a predetermined threshold value.

The auxiliary variable update unit 33 includes an updater for the auxiliary variable λ. The auxiliary variable update unit 33 updates the auxiliary variable λ on the basis of the following Expression (8) and causes the auxiliary variable λ to be stored in the storage 12.

$$[ Math . 5 ]$$

$${λ}^{′} = λ + {γ}_{1} ( {YA}^{′} - F ) \qquad ( 8 )$$

Here, the high-order Ambisonics coefficient A′ is a post-update high-order Ambisonics coefficient in the update operation. The auxiliary variables λ and λ′ are respective auxiliary variables before and after the update in the update operation. The virtual sound source information F is virtual sound source information before update in the update operation. γ1 is a design variable.

The virtual sound source update unit 34 includes an updater for the virtual sound source information F. The virtual sound source update unit 34 updates the virtual sound source information F on the basis of the following Expression (9) and causes the virtual sound source information F to be stored in the storage 12.

$$[ Math . 6 ]$$

$${F}^{′} = F - {γ}_{2} {λ}^{′} \qquad ( 9 )$$

Here, the virtual sound source information F′ is the virtual sound source information after update in the update operation. γ2 is a design variable.

The evaluation unit 27 updates the parameter P so as to minimize an error of the output audio information F\hat{ } with respect to the teacher audio information Lau. Specifically, the parameter P is a bias term and a weight that determine the characteristics of the neural network provided in each of the video feature amount calculation unit 22, the audio feature amount calculation unit 23, and the coefficient update unit 32. For calculating the parameter P, the evaluation unit 27 uses, for example, error back propagation algorithm.

Every time the parameter P is updated, the evaluation unit 27 applies the updated parameter P to each of the video feature amount calculation unit 22, the audio feature amount calculation unit 23, and the coefficient update unit 32. When the evaluation end condition is satisfied, the evaluation unit 27 causes the last updated parameter Pe to be stored in the storage 12 as the learned model 28.

### 3.1.2 Restoration Function

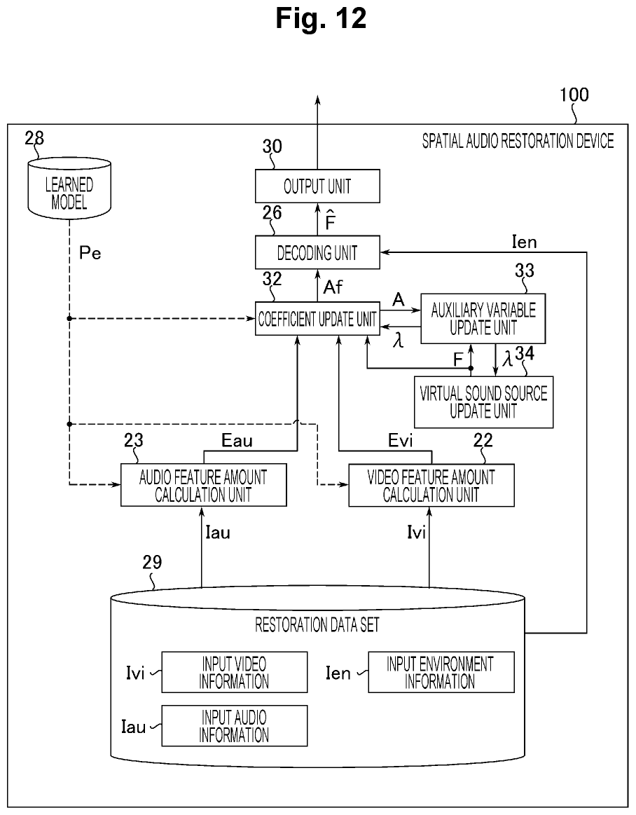

FIG. 12 is a block diagram illustrating an example of a configuration of a restoration function of the spatial audio restoration device according to the third embodiment. FIG. 12 corresponds to FIG. 4 in the first embodiment and FIG. 8 in the second embodiment.

The CPU of the control circuit 11 deploys the restoration operation program stored in the storage 12 or the storage medium 16 into the RAM. Then, the CPU of the control circuit 11 interprets and executes the program deployed in the RAM. Thus, the control circuit 11 functions as a computer including the video feature amount calculation unit 22, the audio feature amount calculation unit 23, the decoding unit 26, the output unit 30, the coefficient update unit 32, the auxiliary variable update unit 33, and the virtual sound source update unit 34. Further, the storage 12 stores the learned model 28 and the restoration data set 29.

Since the configurations of the video feature amount calculation unit 22, the audio feature amount calculation unit 23, the decoding unit 26, the coefficient update unit 32, the auxiliary variable update unit 33, and the virtual sound source update unit 34 in FIG. 12 are equivalent to the configurations of the video feature amount calculation unit 22, the audio feature amount calculation unit 23, the decoding unit 26, the coefficient update unit 32, the auxiliary variable update unit 33, and the virtual sound source update unit 34 in FIG. 11, the description thereof will be omitted. In addition, since the configurations of the restoration data set 29 and the output unit 30 in FIG. 12 are equivalent to the configurations of the restoration data set 29 and the output unit 30 in FIG. 4, the description thereof will be omitted.

The learned model 28 is the parameter Pe generated by the learning operation. The learned model 28 is applied to the neural network provided in each of the video feature amount calculation unit 22, the audio feature amount calculation unit 23, and the coefficient update unit 32 at the time of the restoration operation.

### 3.2 Operation

Next, an operation of the spatial audio restoration device according to the third embodiment will be described.

### 3.2.1 Learning Operation

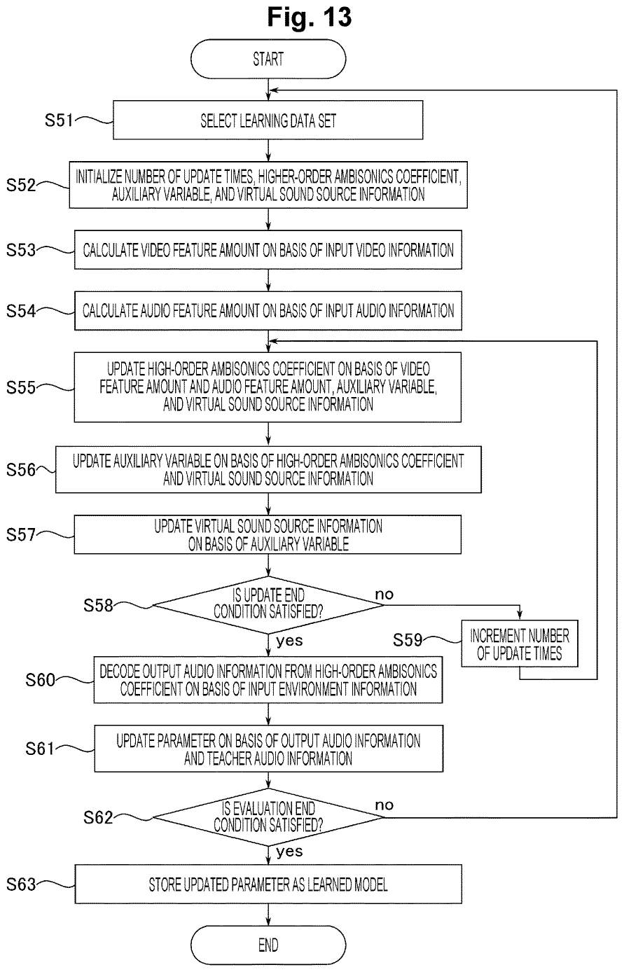

FIG. 13 is a flowchart illustrating an example of a learning operation in the spatial audio restoration device according to the third embodiment. FIG. 13 corresponds to FIG. 5 in the first embodiment and FIG. 9 in the second embodiment.

Upon receiving an instruction to execute the learning operation from the user U (start), the control circuit 11 selects one unselected learning data set 21 from the plurality of learning data sets 21 (S51).

The control circuit 11 initializes the number of update times x of the update operation, the high-order Ambisonics coefficient A, the auxiliary variable λ, and the virtual sound source information F (S52).

The number of update times x is initialized to 0, for example. Each of the high-order Ambisonics coefficient A, the auxiliary variable λ, and the virtual sound source information F is initialized to a random number, for example. The virtual sound source information F may be initialized to monaural sound (for example, the input audio information Iau).

The video feature amount calculation unit 22 calculates the video feature amount Evi on the basis of the input video information Ivi in the learning data set 21 selected in the processing of S51 (S53).

The audio feature amount calculation unit 23 calculates the audio feature amount Eau on the basis of the input audio information Iau in the learning data set 21 selected in the processing of S51 (S54).

The coefficient update unit 32 updates the high-order Ambisonics coefficient A on the basis of the auxiliary variable λ initialized by the processing of S52 and the virtual sound source information F, the video feature amount Evi calculated by the processing of S53, and the audio feature amount Eau calculated by the processing of S54 (S55).

The auxiliary variable update unit 33 updates the auxiliary variable λ on the basis of the high-order Ambisonics coefficient A updated in the processing of S55 and the virtual sound source information F initialized in the processing of S52 (S56).

The virtual sound source update unit 34 updates the virtual sound source information F on the basis of the auxiliary variable λ updated in the processing of S56 (S57).

The control circuit 11 determines whether or not the update condition is satisfied (S58).

If the update condition is not satisfied (S58; no), the control circuit 11 increments the number of update times x (S59).

After the processing of S59, the coefficient update unit 32 updates the high-order Ambisonics coefficient A on the basis of the video feature amount Evi calculated in the processing of S53, the audio feature amount Eau calculated in the processing of S54, the auxiliary variable λ updated in the processing of S56, and the virtual sound source information F updated in the processing of S57 (S55).

The auxiliary variable update unit 33 updates the auxiliary variable λ on the basis of the high-order Ambisonics coefficient A updated in the processing of S55 and the virtual sound source information F updated in the processing of S57 (S56).

The virtual sound source update unit 34 updates the virtual sound source information F on the basis of the auxiliary variable λ updated in the processing of S56 (S57).

In this manner, the update operation of S55 to S57 is repeatedly executed until the update end condition is satisfied.

If the update condition is satisfied (S58; yes), the decoding unit 26 decodes the output audio information F\hat{ } from the high-order Ambisonics coefficient Af last updated in the processing of S55 on the basis of the input environment information Ien in the learning data set 21 selected in the processing of S51 (S60).

The evaluation unit 27 updates the parameter P on the basis of the teacher audio information Lau in the learning data set 21 selected in the processing of S31 and the output audio information F\hat{ } decoded in the processing of S60 (S61).

The evaluation unit 27 determines whether or not the evaluation end condition is satisfied (S62).

If the evaluation end condition is not satisfied (S62; no), the control circuit 11 selects one unselected learning data set 21 from the plurality of learning data sets 21 (S51). Then, the control circuit 11 executes subsequent processing of S52 to S62. In this manner, the processing of S51 to S62 is repeatedly executed until the evaluation end condition is satisfied.

If the evaluation end condition is satisfied (S62; yes), the evaluation unit 27 causes the parameter Pe last updated in the processing of S61 to be stored in the storage 12 as the learned model 28 (S63).

After the processing of S63, the learning operation ends (ends).

### 3.2.2 Restoration Operation

Next, a restoration operation in the spatial audio restoration device according to the third embodiment will be described.

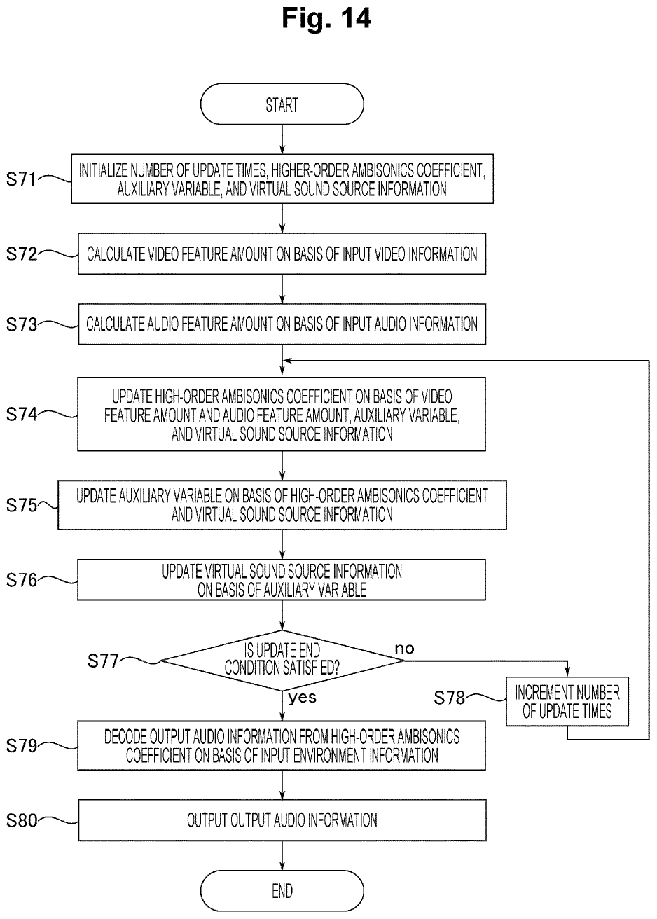

FIG. 14 is a flowchart illustrating an example of a restoration operation in the spatial audio restoration device according to the third embodiment. FIG. 14 corresponds to FIG. 6 in the first embodiment and FIG. 10 in the second embodiment.

Upon receiving an instruction to execute the restoration operation from the user U (start), the control circuit 11 initializes the update times x of the update operation, the high-order Ambisonics coefficient A, the auxiliary variable λ, and the virtual sound source information F (S71).

The video feature amount calculation unit 22 calculates the video feature amount Evi on the basis of the input video information Ivi in the restoration data set 29 (S72).

The audio feature amount calculation unit 23 calculates the audio feature amount Eau on the basis of the input audio information Iau in the restoration data set 29 (S73).

The coefficient update unit 32 updates the high-order Ambisonics coefficient A on the basis of the auxiliary variable λ initialized by the processing of S71 and the virtual sound source information F, the video feature amount Evi calculated by the processing of S72, and the audio feature amount Eau calculated by the processing of S73 (S74).

The auxiliary variable update unit 33 updates the auxiliary variable λ on the basis of the high-order Ambisonics coefficient A updated in the processing of S74 and the virtual sound source information F initialized in the processing of S71 (S75).

The virtual sound source update unit 34 updates the virtual sound source information F on the basis of the auxiliary variable λ updated in the processing of S75 (S76).

The control circuit 11 determines whether or not the update condition is satisfied (S77).

If the update condition is not satisfied (S77; no), the control circuit 11 increments the number of update times x (S78).

After the processing of S78, the coefficient update unit 32 updates the high-order Ambisonics coefficient A on the basis of the video feature amount Evi calculated in the processing of S72, the audio feature amount Eau calculated in the processing of S73, the auxiliary variable λ updated in the processing of S75, and the virtual sound source information F updated in the processing of S76 (S74).

The auxiliary variable update unit 33 updates the auxiliary variable λ on the basis of the high-order Ambisonics coefficient A updated in the processing of S74 and the virtual sound source information F updated in the processing of S76 (S75).

The virtual sound source update unit 34 updates the virtual sound source information F on the basis of the auxiliary variable λ updated in the processing of S75 (S76).

In this manner, the update operation of S74 to S76 is repeatedly executed until the update end condition is satisfied.

If the update condition is satisfied (S77; yes), the decoding unit 26 decodes the output audio information F\hat{ } from the high-order Ambisonics coefficient Af last updated in the processing of S74 on the basis of the input environment information Ien in the restoration data set 29 (S79).

The output unit 30 outputs the output audio information F\hat{ } decoded in the processing of S79 to the plurality of speakers SP (S80).

When the processing of S80 ends, the restoration operation ends (ends).

### 3.3 Effects According to Third Embodiment

According to the third embodiment, the coefficient update unit 32 calculates and updates the high-order Ambisonics coefficient A on the basis of the video feature amount Evi, the audio feature amount Eau, the auxiliary variable λ, and the virtual sound source information F. The auxiliary variable update unit 33 updates the auxiliary variable λ on the basis of the updated high-order Ambisonics coefficient A and the virtual sound source information F. The virtual sound source update unit 34 updates the virtual sound source information F on the basis of the updated auxiliary variable λ. Thus, the accuracy of the high-order Ambisonics coefficient A applied to the decoding unit 26 can be improved.

Further, in a case where the number of update operations by the coefficient update unit 32, the auxiliary variable update unit 33, and the virtual sound source update unit 34 is equal to or more than a predetermined threshold value, the update operation ends. In this manner, by executing the update operation a plurality of times, the decoding operation by the subsequent decoding unit 26 can be executed after the accuracy of the high-order Ambisonics coefficient A is sufficiently improved. Thus, the output audio information F\hat{ } in which the richer spatial audio is restored can be generated.

Further, the evaluation unit 27 updates the parameter P of the neural network included in each of the video feature amount calculation unit 22, the audio feature amount calculation unit 23, and the coefficient update unit 32 on the basis of the comparison result between the output audio information F\hat{ } and the teacher audio information Lau. Thus, the estimation accuracy of the video feature amount Evi, the audio feature amount Eau, and the high-order Ambisonics coefficient A by the neural network can be improved.

### 4. Others

Note that various modifications can be applied to the first embodiment, the second embodiment, and the third embodiment described above.

In the first embodiment, the second embodiment, and the third embodiment described above, the case where the program for executing the learning operation and the restoration operation is executed by the spatial audio restoration device 100 has been described, but the program is not limited thereto. For example, the programs for executing the learning operation and the restoration operation may be executed on a calculation resource on a cloud.

Further, in the first embodiment, the second embodiment, and the third embodiment described above, the case where the audio feature amount Eau is calculated after the calculation of the video feature amount Evi has been described, but it is not limited thereto. For example, the audio feature amount Eau may be calculated before the calculation of the video feature amount Evi. In addition, for example, the calculation of the video feature amount Evi and the calculation of the audio feature amount Eau may be executed in parallel.

Further, in the first embodiment, the second embodiment, and the third embodiment described above, the case where the parameter P is updated by comparing the output audio information F\hat{ } with the teacher data has been described, but it is not limited thereto. For example, the parameter P may be updated by comparing the high-order Ambisonics coefficient A with the teacher data. That is, the teacher audio information Lau may be a high-order Ambisonics coefficient that restores a true sound field. In this case, in the processing of S17 in FIG. 5 of the first embodiment, the evaluation unit 27 updates the parameter P on the basis of the teacher audio information Lau in the learning data set 21 selected in the processing of S10 and the high-order Ambisonics coefficient A encoded in the processing of S15. In the processing of S36 in FIG. 9 of the second embodiment, the evaluation unit 27 updates the parameter P on the basis of the teacher audio information Lau in the learning data set 21 selected in the processing of S31 and the high-order Ambisonics coefficient A calculated in the processing of S34. In the processing of S61 in FIG. 13 of the third embodiment, the evaluation unit 27 updates the parameter P on the basis of the teacher audio information Lau in the learning data set 21 selected in the processing of S31 and the high-order Ambisonics coefficient Af last updated in the processing of S55.

Note that the present invention is not limited to the above embodiments, and various modifications can be made in the implementation stage without departing from the gist of the invention. In addition, embodiments may be implemented in appropriate combination, and in this case, a combined effect can be obtained. In addition, the embodiment described above include various aspects of the invention, and the various aspects of the invention can be extracted by combinations selected from a plurality of disclosed constituent elements. For example, in a case where the problems can be solved and the advantageous effects can be obtained even if some constituent elements are deleted from all the constituent elements described in the embodiment, a configuration from which the constituent elements are deleted can be extracted as an invention.

### REFERENCE SIGNS LIST

1 Spatial audio restoration system
11 Control circuit
12 Storage
13 Communication module
14 Interface
15 Drive
16 Storage medium
21 Plurality of learning data sets
22 Video feature amount calculation unit
23 Audio feature amount calculation unit
24 Virtual sound source generation unit
25 Encoding unit
26 Decoding unit
27 Evaluation unit
28 Learned model
29 Restoration data set
30 Output unit
31 Coefficient calculation unit
32 Coefficient update unit
33 Auxiliary variable update unit
34 Virtual sound source update unit
100 Spatial audio restoration device
SP Plurality of speakers
SS Plurality of virtual sound sources
U User

1. A spatial audio restoration device comprising:
one or more processors configured to:
calculate a video feature amount on a basis of video information;
calculate an audio feature amount on a basis of audio information that is a monaural sound corresponding to the video information; and
calculate a high-order Ambisonics coefficient on a basis of the video feature amount and the audio feature amount.

2. The spatial audio restoration device according to claim 1, wherein
the high-order Ambisonics coefficient corresponds to virtual sound source information that is a sound field formed by a virtual sound source independent of the video information.

3. The spatial audio restoration device according to claim 2, wherein the spatial audio restoration device comprises one or more processors configured to:
generate the virtual sound source information on a basis of the video feature amount and the audio feature amount, and
encode the virtual sound source information into the higher-order Ambisonics coefficient.

4. The spatial audio restoration device according to claim 2, wherein the spatial audio restoration device comprises one or more processors configured to:
update the high-order Ambisonics coefficient on a basis of the video feature amount, the audio feature amount, the virtual sound source information, and an auxiliary variable,
update the auxiliary variable on a basis of the updated high-order Ambisonics coefficient and the virtual sound source information, and
update the virtual sound source information on a basis of the updated auxiliary variable.

5. The spatial audio restoration device according to claim 4, wherein
when a number of update operations by the one or more processors of the spatial audio restoration device is equal to or more than a predetermined threshold value, the one or more processors of the spatial audio restoration device are configured to end the update operation.

6. The spatial audio restoration device according to claim 1, wherein the spatial audio restoration device comprises one or more processors configured to:
decode output audio information from the high-order Ambisonics coefficients; and
update a parameter of a neural network of the spatial audio restoration device on a basis of a comparison result between the output audio information or the higher order Ambisonics coefficient and teacher audio information.

7. A spatial audio restoration method comprising:
calculating a video feature amount on a basis of video information;
calculating an audio feature amount on a basis of audio information that is a monaural sound corresponding to the video information; and
calculating a high-order Ambisonics coefficient on a basis of the video feature amount and the audio feature amount.

8. A non-transitory computer readable medium storing one or more programs, that upon execution by a computer, cause the computer to function as a spatial audio restoration device that performs operations comprising:
calculating a video feature amount on a basis of video information;
calculating an audio feature amount on a basis of audio information that is a monaural sound corresponding to the video information; and
calculating a high-order Ambisonics coefficient on a basis of the video feature amount and the audio feature amount.
